(19) United States
(12) Patent Application Publication
(10) Pub. No.: US 2011/0020703 A1
(43) Pub. Date: Jan. 27, 2011

(54) CATHODE PLATE FOR SECONDARY BATTERY, MANUFACTURING METHOD THEREOF AND SECONDARY BATTERY PROVIDED WITH THE CATHODE PLATE

(76) Inventors: Tomonori SUZUKI, Iwaki-shi (JP); Hidetoshi Abe, Iwaki-shi (JP); Yasuhiro Wakizaka, Tokyo (JP)

Correspondence Address: BIRCH STEWART KOLASCH & BIRCH, PO BOX 747, FALLS CHURCH, VA, 22040-0747, US

(21) Appl. No.: 12/893,688

(22) Filed: Sep. 29, 2010

Related U.S. Application Data
(63) Continuation of application No. PCT/JP2009/056739, filed on Mar. 31, 2009.

(30) Foreign Application Priority Data
Mar. 31, 2008 (JP) 2008-092539

(51) Int. Cl. H01M 4/58; B05D 5/12

(52) U.S. Cl. 429/221; 427/77

(57) ABSTRACT

Disclosed is a cathode plate for a secondary battery, which includes a collector, and a cathode active material layer, wherein the cathode active material layer is formed of multiple layers of coating films formed on a surface of the collector and obtained by application and drying of an aqueous paste, which is obtained by kneading and dispersing an iron lithium phosphate material having an olivine structure as the cathode active material, an electroconductive material, a water-soluble thickner, a binder, and water as a dispersion medium.

### CROSS-REFERENCE TO RELATED APPLICATIONS

This is a Continuation Application of PCT Application No. PCT/JP2009/056739, filed Mar. 31, 2009, which was published under PCT Article 21(2) in Japanese.

This application is based upon and claims the benefit of priority from prior Japanese Patent Application No. 2008-092539, filed Mar. 31, 2008, the entire contents of which are incorporated herein by reference.

### BACKGROUND OF THE INVENTION

1. Field of the Invention

The present invention relates to a cathode plate for a secondary battery, to a manufacturing method thereof, and to a secondary battery provided with the cathode plate.

2. Description of the Related Art

In recent years, in conformity with the rapid development in the field of electronics, electronic equipment is now increasingly advanced in performance, miniaturization and portability thereof and hence there are increasing demands for the development of a secondary battery for use in these electronic equipments, which is rechargeable and high in energy density. As for the secondary batteries to be mounted on these electronic equipments, a Ni—Cd battery, a nickel-hydrogen battery, etc., are generally used. However, the batteries which are capable of exhibiting a further higher energy density are now demanded.

Under the circumstances described above, the researches and developments on lithium secondary batteries have been recently extensively conducted and some of lithium secondary batteries are now practically used. In these lithium secondary batteries, a anode containing metallic lithium, a lithium alloy, or a carbonaceous material capable of electrochemically absorbing/desorbing lithium ion as a anode active material and a cathode containing lithium-containing composite oxides, chalcogen compounds, etc., as a cathode active material are assembled to form the battery.

The secondary batteries of this kind are higher in cell voltage and also higher in energy density per weight and volume as compared with the conventional secondary batteries. Therefore, the secondary batteries of this kind are considered as being most expectable secondary batteries in future.

As for the cathode active materials to be used in the batteries of this kind, LiCoO₂, LiNiO₂ and LiMn₂O₄ are mainly used. Recently, the application of these active materials of the cathode to a large-sized battery having a large capacity for use in a power storage device or in an electric vehicle is now extensively studied. In conformity with the increase in size of the battery for these applications and in view of safety and cost saving, iron lithium phosphate which is an ironic material is attracting many attentions for use as a cathode active material.

The cathode using iron lithium phosphate as an active material is generally manufactured by dispersing iron lithium phosphate together with a electroconductive material and a binder in an organic solvent such as N-methyl-2-pyrrolidone (NMP) to create a paste; coating the surface of aluminum foil with the paste in most cases; drying the paste; subjecting the coated aluminum foil to press working; and cutting the resultant aluminum foil to manufacture a cathode plate.

The use of the organic paste as described above is however accompanied by problems that the manufacturing cost is increased because of the use of the organic paste, that the organic solvent is required to be recovered in the step of drying the paste while giving careful consideration to the environments, and that since the organic paste is combustible, explosion-proof is required to be taken into consideration, resulting in the increase of manufacturing cost.

In view of these problems, there has been proposed a method of using an aqueous paste in place of the organic paste (for example, JP-A 2005-63825). According to this proposal, since no kind of organic solvent is used, the aforementioned problems can be obviated.

As for the prior art related to the cathode of lithium secondary batteries, there has been proposed a method wherein the cathode is formed of a multi-layer structure comprising a plurality of active material layers, each layer respectively containing different kinds of active materials from each other (for example, JP-A 2007-26676).

However, as a result of intensive studies made by the present inventors, various problems have been found out as described below. Namely, when an aqueous paste is coated relatively thickly as described in JP-A 2005-63825, there will be raised no problem as long as the area to be coated is limited to a small area. However, when the aqueous paste is coated on a relatively large area, the migration (uneven distribution) of a binder or a electroconductive material is caused to occur on drying the aqueous paste, thereby raising problems that it is impossible to secure the porosity and uniformity of the cathode plate to be manufactured and that the coated layer is caused to peel off from the collector after the drying process of the coated layer.

Further, it has been found out that, in the case where the cathode is formed of a multi-layer structure comprising a plurality of active material layers, each layer respectively containing different kinds of active materials from each other as described in JP-A 2007-26676, since the cathode is formed of a laminated layer consisting of different active material layers and the thickness of the coated layer inevitably becomes large, the migration of a binder and a electroconductive material is caused to occur, thereby raising the same problems as described above, i.e., it is impossible to secure the porosity and uniformity of the cathode plate to be manufactured and the coated layer is caused to peel off from the collector after the drying process of the coated layer.

### BRIEF SUMMARY OF THE INVENTION

An object of the present invention is to provide a cathode plate for a secondary battery, which is not only capable of inhibiting the migration of a binder and a electroconductive material on drying a coated paste layer to thereby secure the porosity and uniformity of the cathode plate but also capable of increasing the electrode capacity without giving rise to cracking or peeling of the coated film layer due to the stress produced on drying a coated paste layer.

Another object of the present invention is to provide a method of manufacturing a cathode plate for a secondary battery, which makes it possible to inhibit the migration of a binder and a electroconductive material on drying a coated paste layer to thereby secure the porosity and uniformity of the cathode plate and also to increase the electrode capacity without giving rise to cracking or peeling of the coated film layer due to the stress produced on drying a coated paste layer.

A further object of the present invention is to provide a secondary battery which is equipped with the aforementioned cathode plate.

According to a first aspect of the present invention, there is provided a cathode plate for a secondary battery, which comprises: a collector; and a cathode active material layer, wherein the cathode active material layer is formed of multiple layers of coating films formed on a surface of the collector and obtained by application and drying of an aqueous paste, which is obtained by kneading and dispersing an iron lithium phosphate material having an olivine structure as a cathode active material, an electroconductive material, a water-soluble thickner, a binder, and water as a dispersion medium.

According to a second aspect of the present invention, there is provided a method of manufacturing a cathode plate for a secondary battery, which comprises: coating repeatedly a plurality of times a surface of a collector with an aqueous paste obtained by kneading a mixture containing an iron lithium phosphate material having an olivine structure as a cathode active material, a electroconductive material, a water-soluble thickner, a binder, and water as a dispersion medium; and drying to obtain a multi-layer coated film, thereby manufacturing the cathode plate.

According to a third aspect of the present invention, there is provided a nonaqueous electrolytic secondary battery comprising the cathode plate described above, a anode plate, and a nonaqueous electrolyte.

In the first to third embodiments described above, it is possible to used as the iron lithium phosphate material, iron lithium phosphate or a iron lithium phosphate compound represented by a formula of LiFe_{1-X}M_{X}PO₄ (wherein M is at least one kind of metal selected from the group consisting of Al, Mg, Ti, Nb, Co, Ni and M; and 0<x<0.3).

In this case, the primary particle diameter of the iron lithium phosphate material may be not more than 1 μm. Further, the iron lithium phosphate material has carbon coating on its surface or forms a composite material with carbon.

A number of coated paste layers may be confined to 2 to 5. The coated paste layers may be respectively coated such that a dry weight per unit area of one coated paste layer decreases with decreasing proximity to the collector. The dry weight per unit area of a first paste layer on the collector may be 2-10 mg/cm² and the dry weight per unit area of a second paste layer on the first paste layer may be 1.2-8 mg/cm².

### BRIEF DESCRIPTION OF THE SEVERAL VIEWS OF THE DRAWING

FIG. 1 is a cross-sectional view illustrating a cathode plate according to one embodiment of the present invention; and

FIG. 2 is a cross-sectional view illustrating a secondary battery which is equipped with the cathode plate shown in FIG. 1.

### DETAILED DESCRIPTION OF THE INVENTION

Next, various embodiments of the present invention will be explained.

It has been found out as a result of intensive studies made by the present inventors on the above-described problems that it is possible to obtain a cathode plate having an increased film thickness and an enlarged area and exhibiting excellent discharging rate characteristics by making use of an iron lithium phosphate compound as a cathode active material for creating a multi-layer structure containing this active material, a electroconductive material and a binder. Based on this finding, the present invention has been accomplished.

Namely, the cathode plate for a secondary battery according to the present invention is characterized in that it is created in such a manner that an aqueous paste formed by kneading of a mixture containing an iron lithium phosphate material as a cathode active material, a electroconductive material, a water-soluble thickner, a binder and water as a dispersion medium is repeatedly coated a plurality of times on the surface of a collector to obtain a multi-layer structure which is then dried to obtain the cathode plate.

According to the cathode plate for a secondary battery of the present invention which is constructed as described above, it is possible to prevent the migration of the binder and electroconductive material contained in the aqueous paste and hence to sufficiently secure the porosity and uniformity of the coated film layer, and to increase the coating amount relative to the apparent area of collector without occurrence of cracking and peeling of the coated film layer in the process of drying the paste. As a result, it is possible to increase the capacity of the electrode per unit area. Further, since an aqueous paste is used, the manufacturing operation can be performed safely without permitting the discharge of organic solvents during the drying step in the manufacture of the cathode plate.

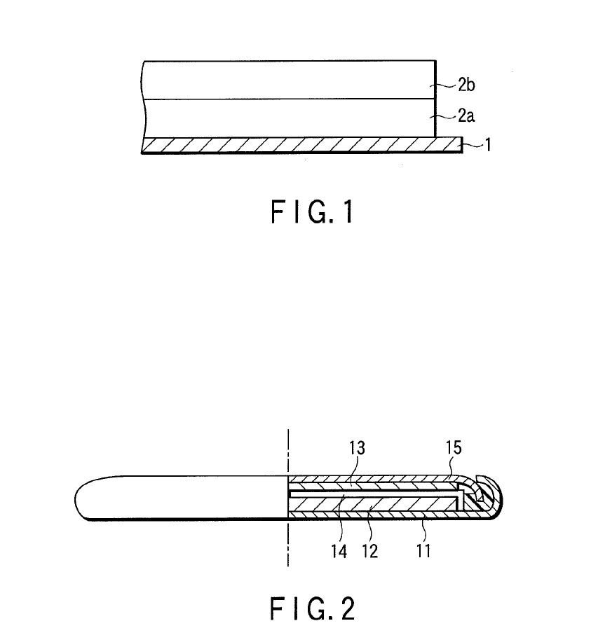

FIG. 1 is a cross-sectional view illustrating the cathode plate for a secondary battery according to one embodiment of the present invention. As shown in FIG. 1, this cathode plate for a secondary battery is constructed such that a first cathode active material layer 2a and a second cathode active material layer 2b are successively laminated one another on one of the main surfaces of a collector 1.

The cathode plate for a secondary battery as shown in FIG. 1 can be obtained by a process wherein an aqueous paste is coated on the surface of the collector 1 in such a quantity that would not bring about the occurrence of cracking and peeling of the coated film and then dried to form the first cathode active material layer 2a. Thereafter, the aqueous paste is again coated on the surface of the first cathode active material layer 2a and dried in the same manner to form the second cathode active material layer 2b.

Incidentally, although FIG. 1 illustrates a case wherein the cathode active material layer has a 2-ply structure, the cathode active material layer has a 3- or more-ply structure. The multi-layer structure of the cathode active material layer described above is effective in increasing the coating amount of paste per apparent area of collector and in increasing the capacity of the electrode.

In the cathode plate for a secondary battery according to the present invention, an iron lithium phosphate material having an olivine structure is used as a cathode active material. By the term “iron lithium phosphate material having an olivine structure” described in the present invention, it is intended to include not only iron lithium phosphate but also an iron lithium phosphate compound wherein a portion of the iron of iron lithium phosphate is replaced by another kind of metal. Preferable examples such an iron lithium phosphate compound include those represented by a general formula of LiFe_{1-X}M_{X}PO₄ (wherein M is at least one kind of metal selected from the group consisting of Al, Mg, Ti, Nb, Co, Ni and M; and 0<x<0.3).

The iron lithium phosphate material to be used as a cathode active material may preferably be selected from those having a primary particle diameter of not more than 1 μm, more preferably not more than 0.5 μm. By confining the primary particle diameter of the iron lithium phosphate material to not more than 1 μm, more preferably not more than 0.5 μm, it is now possible to facilitate the intercalation of Li ion.

Further, in order to realize excellent conductivity of the electrode, it is preferable to use an iron lithium phosphate material having carbon coating applied to the surface of particle or a composite material consisting of carbon and an iron lithium phosphate material. The carbon coating can be performed by adding sucrose as a carbonaceous source to the iron lithium phosphate material and subjecting the resultant mixture to a heat treatment to thereby form a thin film on the surface of particles of iron lithium phosphate material.

As for specific examples of the electroconductive material to be contained in the aqueous paste, they include electrically conductive carbon such as acetylene black, ketjen black, furnace black, carbon fiber, graphite, etc.; conductive polymer; and metallic powder. Among them, the use of electrically conductive carbon is especially preferable. Preferably, these electrically electroconductive materials may be used at a ratio of not more than 20 parts by weight based on 100 parts by weight of the cathode active material. More preferably, these electroconductive materials may be used at a ratio of not more than 10 parts by weight but not less than one part by weight based on 100 parts by weight of the cathode active material.

With respect to specific examples of the water-soluble thickner, they include carboxylmethyl cellulose, methyl cellulose, hydroxylethyl cellulose, polyethylene oxide, etc. Preferably, these water-soluble thickners may be used at a ratio of 0.1-4.0 parts by weight based on 100 parts by weight of the cathode active material. More preferably, these water-soluble thickners may be used at a ratio of 0.5-3.0 parts by weight based on 100 parts by weight of a cathode active material. When the mixing quantity of the water-soluble thickner is higher than 4.0 parts by weight, the cell resistance of the secondary battery to be obtained would be increased to thereby deteriorate the discharging rate characteristics of the battery. When the mixing quantity of the water-soluble thickner is less than 0.1 part by weight on the contrary, the aqueous paste would be flocculated. The water-soluble thickner may be used as an aqueous solution. In that case, the water-soluble thickner may be used preferably at a concentration of 0.5-3% by weight.

As for specific examples of the binder, they include a fluorinated binder, acrylic rubber, modified acrylic rubber, styrene-butadiene rubber, acrylic polymer and vinyl polymer. These binders may be used singly or in combination of two or more kinds thereof.

Since it is possible to secure oxidation resistance, sufficient adhesion even if the quantity of binder is relatively small and excellent flexibility of the electrode plate, the use of acrylic polymer is more preferable. As for the mixing ratio of the binder, it is preferable to confine it to the range of 1-10 parts by weight, more preferably 2-7 parts by weight based on 100 parts by weight of a cathode active material. The term “acrylic polymer” includes polymers containing monomeric units consisting of acrylic esters and/or methacrylic esters to be polymerized. The ratio of the monomeric units consisting of acrylic esters and/or methacrylic esters to be polymerized may be not less than 40% by weight in general, preferably not less than 50% by weight, more preferably not less than 60% by weight. Specific examples of the acrylic polymer include homopolymers of acrylic esters and/or methacrylic esters and copolymers comprising other kinds of monomers which are copolymerizable with these homopolymers.

In the present invention, water can be used as a dispersing medium. However, it is also possible to use, other than water, a water-soluble solvent such as an alcoholic solvent, an amine-based solvent, a carboxylic acid-based solvent, a ketone-based solvent, etc., for the purpose of improving the drying property of the active material layer or improving the wettability of the active material layer to the collector.

In the present invention, the aqueous paste may further include, for the purpose of improving the coatability and leveling property of the aqueous paste, a surfactant or a leveling agent such as a water-soluble oligomer in addition to an iron lithium phosphate material having an olivine structure, a electroconductive material, a water-soluble thickner, a binder and a dispersion medium.

The dispersion of various kinds of components in a dispersion medium for obtaining the aqueous paste may be performed by making use of any of known dispersing machines such as a planetary mixer, a dispersion mill, a beads mill, a sand mill, an ultrasonic dispersing machine, a homogenizer, a Henschel mixer, etc.

As for the method of dispersion, since an iron lithium phosphate material having a particle diameter of not more than 1 μm is preferably used, it is more preferable to employ a media dispersion method such as the beads mill and the sand mill, wherein dispersion media of small particle size can be used. The paste that has been created in this manner is effective in retaining a suitable porosity in a coated film that has been formed through coating and drying.

The aqueous paste for coating which contains a cathode active material which has been prepared as described above is coated on a surface of a collector made of a metallic foil. As for the collector, a metallic foil made of a metal such as copper, aluminum, nickel, stainless steel can be used. Among them, it is more preferable to use aluminum for manufacturing the collector for a cathode.

The coating of the aqueous paste to the metallic foil of collector can be performed by making use of any of known coating methods selected from gravure coating, gravure reverse coating, roll coating, Meyer bar coating, blade coating, knife coating, air knife coating, comma coating, slot die coating, slide die coating, dip coating, etc.

In the present invention, the first layer is formed by uniformly coating the aqueous paste at an amount of 2-10 mg/cm², more preferably 3-8 mg/cm² both based on dry weight. After the coating of the aqueous pasted for the first layer, the coated layer is dried to remove the dispersion medium and then the aqueous paste for forming the second layer is uniformly coated and dried to remove the dispersion medium in same manner as described above so as to superimpose the second layer on the first layer. In the present invention, the sequence of the first layer and second layer are counted starting from the collector side.

With respect to the method of drying the aqueous paste, although there is no particular limitation, it is possible to employ, for example, air drying using hot or heated air, vacuum drying, a far infrared radiation heater, etc. The temperature of drying may be confined to the range of 30-130° C. For example, it is preferable to terminate the drying process at the moment when the change in weight of the paste after leaving the coated paste layer for one hour in a hot air drying machine at a temperature of 100° C. becomes 0.1% by weight or less. Thereafter, the dried layer is preferably pressed by making use of a plate press or a roll press.

Incidentally, the coating amount for forming the second paste layer may preferably be limited to the range smaller than that of the first paste layer. For example, the coating amount for forming the second paste layer may be about 60-80% by weight of that of the first paste layer (if the coating amount for forming the first paste layer is 2-10 mg/cm² based on dry weight, the coating amount for forming the second paste layer may be 1.2-8 mg/cm² based on dry weight). If the coating amount for forming the second paste layer is larger than that of the first paste layer, the first coated layer may be peeled off because of the shrinkage of the second paste layer during the drying process thereof. If the third paste layer is to be coated, the coating amount for forming the third paste layer may preferably be limited to the range smaller than that of the second paste layer. If the coating amount for forming an upper paste layer is larger than that of an underlying paste layer, it may give rise to the generation of undesirable phenomenon, i.e., the peeling of the underlying paste layer that has been already coated.

Although there is no particular limitation with regard to the number of coated paste layers for constituting the cathode active material layer, it is preferable to confine the number of coated paste layers to 2- to 5-ply lamination, more preferably, to 2- to 3-ply lamination.

The anode may be formed by making use of an active material which makes it possible to dope or de-dope lithium. For example, it is possible to use pyrolytic carbons; cokes such as pitch coke, needle coke, petroleum coke, etc.; graphite; vitreous carbon; a sintered body of high-polymeric organic foreign matters (carbonated materials to be obtained through the sintering of phenol resin, furan resin, etc., at appropriate temperatures); carbon fiber; activated carbon fiber, etc.; metallic lithium; an alloy-based material such as lithium alloy, Sn-based compounds, etc.; and polymers such as polyacetylene, polyvinyl, etc.

A anode plate can be manufactured according to a process wherein any of these anode active materials, a binder and, if required, a conductivity-imparting assistant are dispersed in a dispersion medium and kneaded to obtain a paste for the anode, which is then coated on the surface of a collector and then subjected to drying/rolling processes to manufacture the anode plate. As for specific materials of the collector for the anode, it is possible to use, for example, copper, nickel, stainless steel, etc. Among them, copper foil is more preferable.

The nonaqueous electrolytic secondary battery of the present invention is featured in that it comprises the aforementioned cathode plate, anode plate and a nonaqueous electrolyte.

Although there is no particular limitation with regard to the electrolyte, it is more preferable to use a nonaqueous electrolyte.

As for specific examples of the nonaqueous electrolyte, it is possible to use, without any particular limitation, those which have been generally used in a lithium secondary battery. They include, for example, a solution of at least one kind of materials selected from inorganic lithium salts such as LiClO₄, LiBF₄, LiPF₆, LiAsF₆, LiCl, LiBr, etc.; and organic lithium salts such as LiBOB, LiB(C₆H₅)₄, LiN(SO₂CF₃)₂, LiC(SO₂CF₃)₃, LiOSO₂CF₃, etc., in at least one kind of solvent selected from the group consisting of cyclic esters such as propylene carbonate, ethylene carbonate, butylene carbonate, γ-butyrolactone, vinylene carbonate, 2-methyl-γ-butyrolactone, acetyl-γ-butyrolactone, γ-valerolactone, etc.; cyclic ethers such as tetrahydrofuran, alkyl tetrahydrofuran, dialkyl tetrahydrofuran, alkoxy tetrahydrofuran, dialkoxy tetrahydrofuran, 1,3-dioxorane, alkyl-1,3-dioxorane, 1,4-dioxorane, etc.; linear ethers such as 1,2-dimethoxy ethane, 1,2-diethoxy ethane, diethyl ether, ethyleneglycol dialkyl ether, diethyleneglycol dialkyl ether, triethyleneglycol dialkyl ether, tetraethyleneglycol dialkyl ether, etc.; linear esters such as dimethyl carbonate; methylethyl carbonate; diethyl carbonate; alkyl propionate; dialkyl malonate; dialkyl malonate; alkyl acetate; etc. It is especially preferable to use a solution of LiBF₄, LiPF₆, LiBOB or a mixture thereof in at least one kind of organic solvents described above.

Although there is no particular limitation with regard to the separator as long as the separator is insoluble in the aforementioned electrolyte components, it is preferable to use a single layer structure or a multi-layer structure of fine porous film formed of polyolefin such as polypropylene, polyethylene, etc. It is especially preferable to use a multi-layer structure of fine porous film.

The cathode plate of the present invention is combined with a known anode plate for nonaqueous electrolyte, a nonaqueous electrolyte, a separator, etc., to fabricate a nonaqueous electrolytic secondary battery. With respect to the configuration of the battery, it may be, without any particular limitation, a coin type, a button type, a laminated type, a cylindrical type, a square type, a flat type, etc.

FIG. 2 is a cross-sectional view illustrating one example of a coin type nonaqueous electrolytic secondary battery wherein the cathode plate of the present invention is used. As shown in FIG. 1, this coin type nonaqueous electrolytic secondary battery is constructed such that a separator 14 is interposed between a cathode plate 12 and a anode plate 13 and positioned in a battery case 11 and that the battery case 11 is filled with a nonaqueous electrolyte and sealed by making use of a sealing plate 15.

### Example 1

Iron lithium phosphate was obtained according to the following process. 486 g of lithium phosphate and 795 g of bivalent iron chloride tetrahydrate as a bivalent iron compound were placed together with 2000 mL of distilled water in a pressure-resistive vessel (autoclave), which was then purged with argon gas before being hermetically closed. This pressure-resistive vessel was then heated in an oil bath of 180° C. for 48 hours to allow the contents to react. Subsequently, the reaction product was cooled down to room temperature and taken out of the vessel. Then, the reaction product was dried at 100° C. to obtain a powdery sample.

The powdery sample thus obtained was then analyzed through the X-ray diffraction pattern thereof to confirm that the powdery sample was formed of iron lithium phosphate having an olivine structure. Further, the powdery sample was observed by means of a scanning electron microscope (SEM) to measure the diameter of the primary particle of 100 pieces of iron lithium phosphate which were selected at random. As a result, it was confirmed that the diameter of the primary particle thereof was confined within the range of 20-200 nm.

Then, 10 g of the iron lithium phosphate thus obtained was mixed with 1 g of marketed sugar, as a carbon source, containing sucrose as a main component and additive invert sugar. The resultant mixture was poured into 10 mL of distilled water and sufficiently kneaded. The product thus obtained was dried for two hours at 100° C. to obtain a powdery product, which was then poured in a porcelain crucible and placed in a gas replacement vacuum furnace.

After being sufficiently replaced with nitrogen gas, the powdery product was preliminarily baked for two hours at 300° C. and then subjected to sintering treatment for three hours at 600° C.

Subsequently, the resultant product was allowed to cool down to room temperature and taken out of the crucible to obtain a sample. Since this sample was bulky, it was sufficiently pulverized to manufacture iron lithium phosphate particles having carbon coating.

The content of carbon of the carbon-coated iron lithium phosphate particles was measured by means of thermogravimetric analysis to find it 1.5%.

100 parts by weight of the carbon-coated iron lithium phosphate particles and 10 parts by weight of acetylene black used as electrically conductive carbon were dry-blended in a closed vessel to prepare a powdery mixture. To this powdery mixture was added 100 parts by weight of an aqueous solution containing 2 wt % of carboxymethyl cellulose to obtain a mixture, which was then sufficiently mixed in a planetary mixer to obtain a pre-mixed paste. The pre-mixed paste thus obtained was subjected to a dispersion treatment by means of beads mill using zirconia beads having a diameter of 1 mm and then mixed with an aqueous binder dispersion so as to contain the binder at a ratio of 3 parts by weight as a solid content, thereby obtaining a paste.

As for the aqueous binder dispersion, acrylic polymer (40% by weight as a solid content) was used.

This paste was coated on the surface of a collector made of a solid aluminum foil by making use of a film applicator, thereby forming a paste layer having a thickness of 80 μm. The paste layer was then sufficiently dried in a hot air drying machine. This drying treatment was performed for 10 minutes in the interior of hot air drying machine which was kept at an atmosphere of 50° C. The dry weight of the first paste layer was 5 mg/cm².

The electrode plate thus dried was taken out of the drying machine and cut out to obtain a square sample 10 cm×10 cm in size. After the measurement of weight, the sample was left for one hour in the hot air drying machine which was kept at 100° C. and then measured of its weight. As a result, any substantial reduction of weight was found in the sample, thus confirming that the sample was sufficiently dried in the 10-minute drying process at 50° C. Then, by making use of the same paste formed using the same active material and mixed in the same manner as employed in the formation of the first paste layer, the coating of paste was applied on the surface of the first paste layer and dried for 10 minutes in the interior of hot air drying machine which was kept at an atmosphere of 50° C. in the same manner as in the case of the first paste layer, thereby manufacturing a cathode plate having a coated paste film formed thereon at a ratio of 10 mg/cm² in total after the drying thereof. The cathode thus manufactured was cut out to obtain a sample and the cross-section of the sample was observed by means of SEM. As a result, the boundary between the first paste layer and the second paste layer was scarcely recognized and the peeling of the interface between the first paste layer and the aluminum collector was not recognized, thus confirming that even if the coated paste film was formed into a multi-layer structure, it was possible to secure excellent adhesion of the coated paste film.

### Example 2

The same aqueous paste as used in Example 1 was coated and dried so as to form the first paste layer in a dry weight of 6 mg/cm². Then, by making use of the same paste as that of the first paste layer, the coating of paste was applied on the surface of the first paste layer and sufficiently dried in the hot air drying machine, thereby manufacturing a cathode plate having a total weight of 11 mg/cm² after drying.

### Example 3

The same aqueous paste as used in Example 1 was coated and dried so as to form the first paste layer in a dry weight of 7 mg/cm². Then, by making use of the same paste as that of the first paste layer, the coating of paste was applied on the surface of the first paste layer and sufficiently dried in the hot air drying machine, thereby manufacturing a cathode plate having a total weight of 12 mg/cm² after drying.

### Comparative Example 1

By making use of a film applicator, the same aqueous paste as used in Example 1 was coated once for all so as to form a paste layer in a dry weight of 5 mg/cm². Then, the paste layer was sufficiently dried in a hot air drying machine, thereby manufacturing a cathode plate.

### Comparative Example 2

By making use of a film applicator, the same aqueous paste as used in Example 1 was coated once for all so as to form a paste layer in a dry weight of 6 mg/cm². Then, the paste layer was sufficiently dried in a hot air drying machine, thereby manufacturing a cathode plate.

### Comparative Example 3

By making use of a film applicator, the same aqueous paste as used in Example 1 was coated once for all so as to form a paste layer in a dry weight of 7 mg/cm². Then, the paste layer was sufficiently dried in a hot air drying machine, thereby manufacturing a cathode plate.

### Comparative Example 4

By making use of a film applicator, the same aqueous paste as used in Example 1 was coated once for all so as to form a paste layer in a dry weight of 8 mg/cm². Then, the paste layer was sufficiently dried in a hot air drying machine, thereby manufacturing a cathode plate.

### Comparative Example 5

By making use of a film applicator, the same aqueous paste as used in Example 1 was coated once for all so as to form a paste layer in a dry weight of 9 mg/cm². Then, the paste layer was sufficiently dried in a hot air drying machine, thereby manufacturing a cathode plate.

### Comparative Example 6

By making use of a film applicator, the same aqueous paste as used in Example 1 was coated once for all so as to form a paste layer in a dry weight of 10 mg/cm². Then, the paste layer was sufficiently dried in a hot air drying machine, thereby manufacturing a cathode plate.

(Prior Art 1) 100 parts by weight of the carbon-coated iron lithium phosphate and 10 parts by weight of acetylene black used as electrically conductive carbon were respectively weighed and dry-blended in a closed vessel to prepare a powdery mixture. This powdery mixture was mixed with polyvinylidene fluoride (PVDF #7208) as a binder so as to contain the binder at a ratio of 7 parts by weight as a solid content and with an organic solvent (N-methyl-2-pyrrolidone) as a dispersion medium to obtain a mixture, which was than stirred by means of a planetary mixer to manufacture a premixed paste.

Then, by making use of a film applicator, this paste was coated on the surface of a collector and dried so as to form a paste layer in a dry weight of 10 mg/cm², thereby manufacturing an electrode plate. The electrode plates of above-described Examples and Comparative Examples were respectively cut out to obtain samples each having 10 cm×10 cm in size. Then, the surface of the electrode before and after the rolling was visually observed. The results obtained are shown in the following Table 1.

TABLE 1

| | | | | Cracking and peeling of coated film | |
|---|---|---|---|---|---|
| | | Layer | Dry weight | Before rolling | After rolling |
| | Paste | structure | (mg/cm²) | (cracking) | (peeling) |
| Ex. 1 | Aqueous | 2-ply layer | 1^{st} layer: 5 | None | None |
| | | | 2^{nd} layer: 5 | | |
| Ex. 2 | Aqueous | 2-ply layer | 1^{st} layer: 6 | None | None |
| | | | 2^{nd} layer: 5 | | |
| Ex. 3 | Aqueous | 2-ply layer | 1^{st} layer: 7 | None | None |
| | | | 2^{nd} layer: 5 | | |
| Comp. Ex. 1 | Aqueous | Single layer | 5 | None | None |
| Comp. Ex. 2 | Aqueous | Single layer | 6 | Yes (coated film surface) | None |
| Comp. Ex. 3 | Aqueous | Single layer | 7 | Yes (coated film surface) | None |
| Comp. Ex. 4 | Aqueous | Single layer | 8 | Yes (collector exposed) | None |
| Comp. Ex. 5 | Aqueous | Single layer | 9 | Yes (collector exposed) | Yes (partially) |
| Comp. Ex. 6 | Aqueous | Single layer | 10 | Yes (collector exposed) | Yes (entirely) |
| Prior art 1 | Organic | Single layer | 10 | None | None |

As is apparent from above Table 1, in the cases of Examples 1-3, cracking of coated film on the surface of the electrode was not recognized at all before the rolling step and peeling of coated film after the rolling step was not recognized at all. Whereas, in the cases of Comparative Examples 2-4, although peeling of coated film was not recognized after the rolling, cracking of coated film was recognized before the rolling. In the cases of Comparative Examples 5 and 6 wherein the thickness of coated film was made larger than that of Comparative Examples 2-4, not only the cracking of coated film was recognized before the rolling step but also the peeling of coated film was recognized after the rolling step. Incidentally, in the case of Comparative Example 1, because of the reduced thickness of the coated film, cracking of coated film was not recognized before the rolling step and also peeling of coated film was not recognized after the rolling step. However, since the coated film was formed of a single layer and the coating amount was reduced, it was impossible to obtain a large electrode capacity as compared with that of Examples 1-3.

In the case of Prior art 1, not only the cracking of coated film before the rolling step but also the peeling of coated film after the rolling step was not recognized. However, since the paste was manufactured by making use of an organic solvent in this case, it was accompanied with various conventional problems including the recovery of a solvent in the step of drying the paste while giving careful consideration to the environments and the provision of explosion-proof in addition to the increase of cost for the organic solvent.

The electrode plates of Examples 1-3 and Comparative Examples 1-4 where the peeling of coated film during the rolling step was not recognized were punched to obtain test electrode plates each having a diameter of 14 mm. Coin type batteries each constructed as shown in FIG. 2 were manufactured, wherein a piece of metal Li having a diameter of 15 mm was used as a anode, a fine porous film made of polyethylene was used as a separator, and lithium hexafluorophosphate (LiPF₆) dissolved at a concentration of 1 M in a mixed solvent comprising ethylene carbonate (EC) and ethylmethyl carbonate (ENC) at a weight ratio of 3:7 was used as an electrolyte. Then, the electrical characteristic test of these batteries was performed. The same test was also performed in the same manner on the battery of Prior art 1.

In this test, each of the batteries was charged with a charging current of 0.1 CA until the electrical potential of the test electrode became 4.2 V relative to the equilibrium potential of Li and, after a pause of 10 minutes, discharged with a discharging current of 0.1 CA until the electrical potential of the test electrode became 2.0 V. This charging/discharging cycle for activation was repeated three times to carry out the assessment of the discharging characteristics of the battery. The assessment of discharging rate characteristics of the battery was performed in such a manner that the battery was charged with 0.5 CA and then maintained at 4.2 V for three hours based on the CC-CV method, after which the discharging current was changed to 0.2 CA, 0.5 CA, 1.0 CA, 2.0 CA and 5.0 CA, thereby evaluating the discharging characteristics of the battery. The results obtained are shown in the following Table 2.

TABLE 2

| | 0.2 CA | 0.5 CA | 1.0 CA | 2.0 CA | 5.0 CA |
|---|---|---|---|---|---|
| Ex. 1 | 1.33 | 1.30 | 1.27 | 1.23 | 1.03 |
| Ex. 2 | 1.44 | 1.42 | 1.39 | 1.34 | 1.12 |
| Ex. 3 | 1.56 | 1.54 | 1.51 | 1.46 | 1.21 |
| Comp. | 0.66 | 0.65 | 0.64 | 0.63 | 0.54 |
| Ex. 1 | | | | | |
| Comp. | 0.79 | 0.78 | 0.77 | 0.75 | 0.64 |
| Ex. 2 | | | | | |
| Comp. | 0.92 | 0.91 | 0.89 | 0.87 | 0.74 |
| Ex. 3 | | | | | |
| Comp. | 1.05 | 1.04 | 0.99 | 0.89 | 0.48 |
| Ex. 4 | | | | | |
| Comp. | Impossible to carry out battery characteristics | | | | |
| Ex. 5 | test because of peeling of coated film | | | | |
| Comp. | Impossible to carry out battery characteristics | | | | |
| Ex. 6 | test because of peeling of coated film | | | | |
| Prior | 1.27 | 1.24 | 1.20 | 1.15 | 0.93 |
| art 1 | | | | | |

As is apparent from above Table 2, in the cases of Examples 1-3, owing to the multi-layering of the active material layer, it was possible to increase the coating amount of paste relative to the apparent area of collector and to increase the charging capacity per unit area of the electrode. The reason for these achievements was conceivably attributed to the retention of porosity of the electrode plate. Whereas, in the cases of Comparative Examples 1-4, the coating amount of paste was limited so that it was impossible to a large charging capacity. Furthermore, in the case of Comparative Example 4, the discharging capacity with a current of 0.2 CA was caused to differ greatly from the discharging capacity with a current of 5.0 CA, thus indicating the deterioration of high-rate discharging characteristics. In the cases of Comparative Examples 5 and 6, because of the large thickness of coated film, the coated film was caused to peel off, thereby making it impossible to apply them to the tests. In the case of Prior art 1, although the discharging characteristics of the battery was found excellent, since an organic solvent was used as described above, it was accompanied with various problems including the recovery of a solvent on drying the paste and the provision of explosion-proof.

Incidentally, even if iron lithium phosphate materials containing other kinds of metals substituting for a portion of the iron thereof and represented by a formula of LiFe_{1-X}M_{X}PO₄ (wherein M is at least one kind of metal selected from the group consisting of Al, Mg, Ti, Nb, Co, Ni and M; and 0<x<0.3) were used, it was found possible to achieve substantially the same effects as described above.

What is claimed is:

1. A cathode plate for a secondary battery, which comprises:
a collector; and
a cathode active material layer,
wherein the cathode active material layer is formed of multiple layers of coating films formed on a surface of the collector and obtained by application and drying of an aqueous paste, which is obtained by kneading and dispersing an iron lithium phosphate material having an olivine structure as a cathode active material, an electroconductive material, a water-soluble thickner, a binder, and water as a dispersion medium.

2. The cathode plate according to claim 1, wherein the iron lithium phosphate material is formed of iron lithium phosphate or a iron lithium phosphate compound represented by a formula of LiFe_{1-X}M_{X}PO₄ (wherein M is at least one kind of metal selected from the group consisting of Al, Mg, Ti, Nb, Co, Ni and M; and 0<x<0.3).

3. The cathode plate according to claim 1, wherein a primary particle diameter of the iron lithium phosphate material is not more than 1 μm.

4. The cathode plate according to claim 1, wherein the iron lithium phosphate material has carbon coating on its surface or forms a composite material with carbon.

5. The cathode plate according to claim 1, wherein a number of coated paste layers is confined to 2 to 5.

6. The cathode plate according to claim 1, wherein the coated paste layers are respectively coated such that a dry weight per unit area of one coated paste layer decreases with decreasing proximity to the collector.

7. The cathode plate according to claim 1, wherein a dry weight per unit area of a first paste layer on the collector is 2-10 mg/cm² and a dry weight per unit area of a second paste layer on the first paste layer is 1.2-8 mg/cm².

8. A method of manufacturing a cathode plate for a secondary battery, which comprises:
coating repeatedly a plurality of times a surface of a collector with an aqueous paste obtained by kneading a mixture containing an iron lithium phosphate material having an olivine structure as a cathode active material, a electroconductive material, a water-soluble thickner, a binder, and water as a dispersion medium; and
drying to obtain a multi-layer coated film, thereby manufacturing the cathode plate.

9. The method according to claim 8, wherein the iron lithium phosphate material is formed of iron lithium phosphate or a iron lithium phosphate compound represented by a formula of LiFe_{1-X}M_{X}PO₄ (wherein M is at least one kind of metal selected from the group consisting of Al, Mg, Ti, Nb, Co, Ni and M; and 0<x<0.3).

10. The method according to claim 8, wherein a primary particle diameter of the iron lithium phosphate material is not more than 1 μm.

11. The method according to claim 8, wherein the iron lithium phosphate material has carbon coating on its surface or forms a composite material with carbon.

12. The method according to claim 8, wherein the coating and drying the aqueous paste are repeated 2 to 5 times to form the cathode plate having a 2- to 5-ply coated film.

13. The method according to claim 8, wherein the coated paste layers are respectively coated such that a dry weight per unit area of one coated paste layer decreases with decreasing proximity to the collector.

14. The method according to claim 8, wherein a dry weight per unit area of a first paste layer on the collector is 2-10 mg/cm² and a dry weight per unit area of a second paste layer on the first paste layer is 1.2-8 mg/cm².

15. A nonaqueous electrolytic secondary battery comprising the cathode plate recited in claim 1, a anode plate, and a nonaqueous electrolyte.
